(19) United States
(12) Patent Application Publication
(10) Pub. No.: US 2004/0212856 A1
(43) Pub. Date: Oct. 28, 2004

(54) Method for calibrating an image-scanning module

(76) Inventor: Zhi-Hai Zhang, Suzhou City (CN)

Correspondence Address: SNELL & WILMER, ONE ARIZONA CENTER, 400 EAST VAN BUREN, PHOENIX, AZ, 850040001

(21) Appl. No.: 10/822,311

(22) Filed: Apr. 12, 2004

(30) Foreign Application Priority Data
Apr. 10, 2003 (TW) 92108263

(51) Int. Cl. H04N 1/46; H04N 1/04

(52) U.S. Cl. 358/504; 358/474

(57) ABSTRACT

A method for calibrating an image-scanning module scanning a reference sheet to produce an image is presented. The image-scanning module has a first midpoint, and the reference sheet has a target label. A first label corresponds to a first end of the reference sheet, and a second label corresponds to a second end of the reference sheet. The calibration works out by comparing the actual positions of the first midpoint, the target label, the first label, and the second label with their corresponding coordinate values on the image obtained from scanning the reference sheet.

### CROSS-REFERENCE TO RELATED APPLICATIONS

This application claims priority to Taiwan Patent Application Serial No. 092108263 filed on Apr. 10, 2003.

### FIELD OF INVENTION

The present invention relates to a method for calibrating an image-scanning module. More specifically, it relates to a method for calibrating an image-scanning module by scanning a reference sheet.

### BACKGROUND OF THE INVENTION

An image-scanning module is the most critical component in a scanner. As shown in FIG. 1a, before being assembled into the scanner 100, the image-scanning module 110 needs to undergo various tests and calibrations. For example, the position of the lens may be adjusted to meet a requirement, or the positions of the photo sensors are adjusted to receive the optical signals from the lens more accurately and more efficiently.

FIG. 1b and FIG. 1c are schematic diagrams illustrating a prior art method of calibrating the image-scanning module. The reference sheet 200 has a target label 210 thereon. First, a reference sheet 200 is confined by a confining device 500 to a specific position on the image-scanning module 110. The image-scanning module 110 scans the reference sheet 200 to obtain a corresponding image. Then the image-scanning module is adjusted according to the image information of the target label 210. However, in practice, the relative position of the reference sheet 200 and the image-scanning module 500 varies each time, even with the help of the confining device 500, and thus the calibrations are imperfect. Besides, the magnifying effect caused by the lens would further degrade the calibration.

### SUMMARY OF THE INVENTION

It is an aspect of the present invention to calibrate an image-scanning module.

It is another aspect of the present invention to calibrate an image-scanning module scanning a reference sheet to produce an image.

It is still another aspect of the present invention to compensate the variations during the process when an image-scanning module scans a reference sheet to produce an image.

A method for calibrating an image-scanning module scanning a reference sheet to produce an image is provided. The image-scanning module has a first midpoint, which corresponds to a first midpoint coordinate value on the image, and the reference sheet has a target label. A first label corresponds to a first end of the reference sheet, and a second label corresponds to a second end of the reference sheet. The distance between the first label and the second label is measured as a first value. The calibration is carried out by comparing the actual positions of the first midpoint, the target label, the first label, and the second label with their corresponding coordinate values on the image obtained from scanning the reference sheet.

The presented method includes (a) scanning the reference sheet to obtain a target coordinate value corresponding to the target label, a first coordinate value corresponding to the first label and a second coordinate value corresponding to the second label; (b) obtaining a second midpoint coordinate value according to the first coordinate value and the second coordinate value; (c) calculating a shift value as being the difference between the second midpoint coordinate value and the first midpoint coordinate value; (d) calculating a second value as being the difference between the first coordinate value and the second coordinate value; (e) calculating a magnification as being the ratio of the second value to the first value; and (f) adjusting the target coordinate value to obtain a calibrated target coordinate value according to the shift value and the magnification.

### BRIEF DESCRIPTION OF THE DRAWINGS

FIG. 1a is a schematic diagram of a scanner according to a prior art.

FIG. 1b is a schematic diagram illustrating a prior art method of calibrating the image-scanning module.

FIG. 1c is a schematic diagram of prior art apparatus for calibrating the image-scanning module.

FIG. 2 shows an image-scanning module and a reference sheet according to an embodiment of the presented invention.

FIG. 3 is a flow chart according to an embodiment of the presented invention.

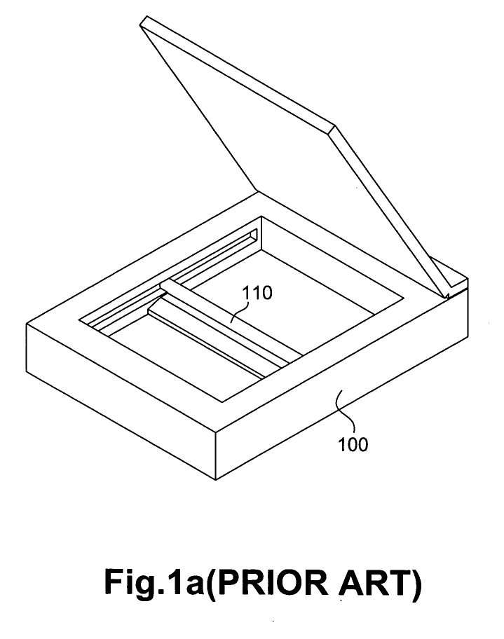

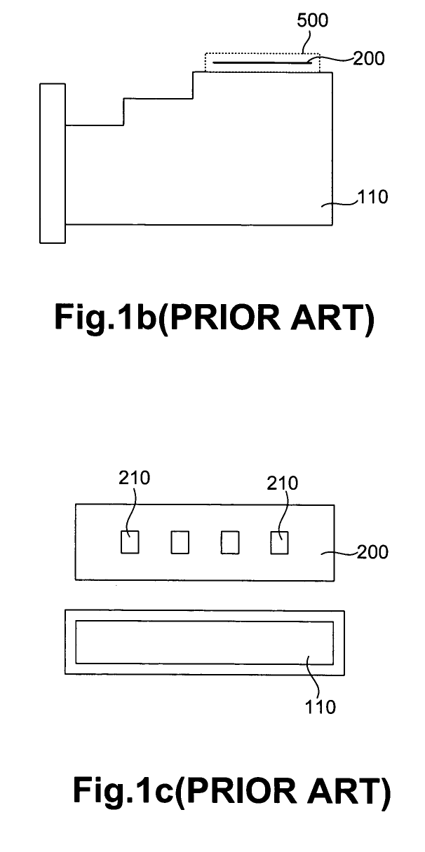

### DETAILED DESCRIPTION

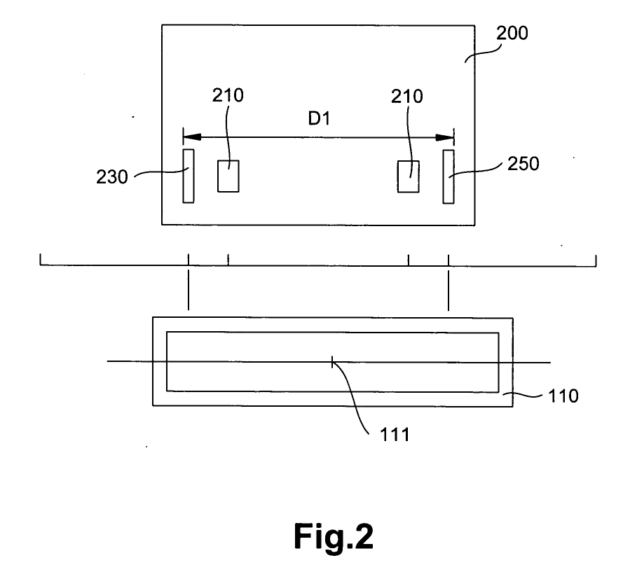

This invention presents a method for calibrating an image-scanning module. According to an embodiment, FIG. 2 shows an image-scanning module 110 and a reference sheet 200. The image-scanning module 110, providing the scanning capability of a scanner, includes lens and photo sensing devices such as a charged coupled device or a contact image sensor. However, a variety of reasons would degrade the uniformity of the scanned image, and the magnifying effect caused by the lens would multiply the variations. Therefore the calibration of the image-scanning module 110 includes the adjustments of the positions of the lens and photo sensing devices, or of other optical elements. Moreover, the adjustments of the sizes of elements in the image-scanning module 110 are also included. And as the method presents, the image-scanning module 110 is calibrated according to the information obtained from scanning the reference sheet 200.

As shown in FIG. 2, the image-scanning module 110 has a first midpoint 111. In an embodiment, it is the scanning area that defines the first midpoint 111. In another embodiment, the first midpoint 111 is the geometric midpoint of the image-scanning module 110. It should be noted that the first midpoint 111, whose position is substantially fixed, corresponds to a first midpoint coordinate value CM1 on the scanned image, and thus the value CM1 is fixed too.

The reference sheet 200 includes a target label 210, a first label 230 corresponding to the first end of the reference sheet 200, and a second label 250 corresponding to the second end of the reference sheet 200. It should be noted that a plurality of target labels on the reference sheets 200 is also allowable. The distance between the first label 230 and the second label 250 is measured as D1. In an embodiment, the target label 210 is a gray-scale patch; the first label 230 and the second label 250 are black segments. In another embodiment, the target label 210, the first label 230, and the second label 250 could be other kinds of marks such as red spots or blue patches.

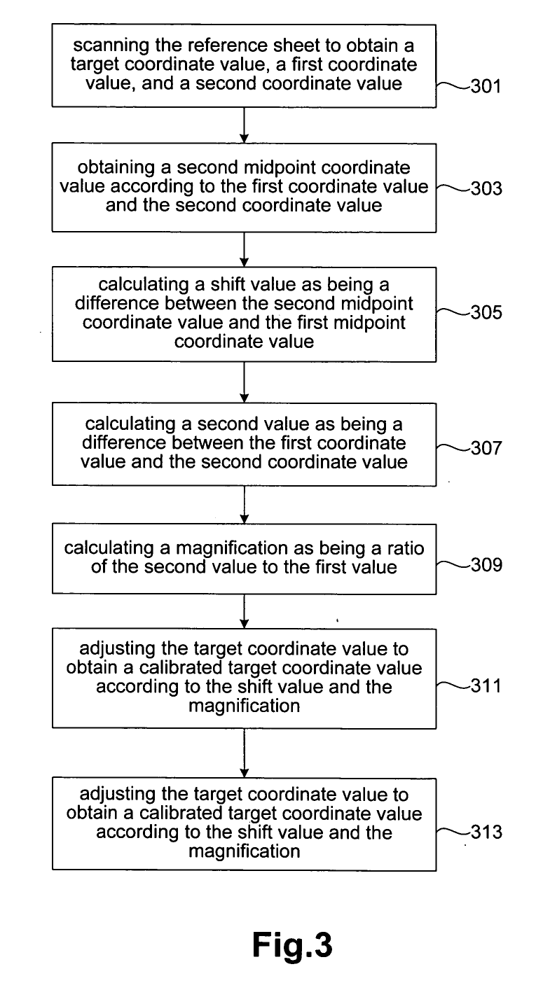

FIG. 3 is a flow chart according to an embodiment of the invention. It begins with the step 301: scanning the reference sheet 200 to obtain an image; on the image being a target coordinate value CT corresponding to the target label 210, a first coordinate value C1 corresponding to the first label 230 and a second coordinate value C2 corresponding to the second label 250.

It proceeds with the step 303: obtaining a second midpoint coordinate value CM2 according to the first coordinate value C1 and the second coordinate value C2. In an embodiment, CM2 is obtained from the average of C1 and C2. Then it turns to the step 305: calculating a shift value S as being the difference between the second midpoint coordinate value CM2 and the first midpoint coordinate value CM1.

Then it moves to the step 307: calculating a second value D2 as being the difference between the first coordinate value C1 and the second coordinate value C2. After that, it goes to the step 309: calculating a magnification M as being the ratio of the second value D2 to the first value D1. The magnification M relates to the magnification ratio of the lens.

Next is the step 311: adjusting the target coordinate value CT to obtain a calibrated target coordinate value CTPRIME according to the shift value S and the magnification M. The calibration process completes with the step 313: setting the target label 210 to correspond to the calibrated target coordinate value CTPRIME.

In an embodiment, the step 311 is construed as adding the shift value S to the target coordinate value CT to obtain the calibrated target coordinate value CTPRIME. This can correct the position variations of the elements in the image-scanning module.

In another embodiment, the step 311 includes normalizing the target coordinate value CT according to the magnificence M to obtain the calibrated target coordinate value CTPRIME. Thus the variation-magnifying effect caused by the lens can be compensated.

In accordance with another embodiment, the step 311 includes adding the shift value S to the target coordinate value CT and then normalizing the target coordinate value CT according to magnificence M to obtain the calibrated target coordinate value CTPRIME.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A method for calibrating an image-scanning module scanning a reference sheet to produce an image, said image-scanning module having a first midpoint, said first midpoint corresponding to a first midpoint coordinate value on said image, said reference sheet including a target label, a first label corresponding to a first end of said reference sheet and a second label corresponding to a second end of said reference sheet, a distance between said first label and said second label being a first value, said method comprising:
(a) scanning said reference sheet to obtain a target coordinate value corresponding to said target label, a first coordinate value corresponding to said first label and a second coordinate value corresponding to said second label;
(b) obtaining a second midpoint coordinate value according to said first coordinate value and said second coordinate value;
(c) calculating a shift value as being a difference between said second midpoint coordinate value and said first midpoint coordinate value;
(d) calculating a second value as being a difference between said first coordinate value and said second coordinate value;
(e) calculating a magnification as being a ratio of said second value to said first value; and
(f) adjusting said target coordinate value to obtain a calibrated target coordinate value according to said shift value and said magnification.

2. The method of claim 1, further comprising: setting said target label to correspond to said calibrated target coordinate value.

3. The method of claim 1, wherein said step (f) comprises adding said shift value to said target coordinate value to obtain said calibrated target coordinate value.

4. The method of claim 3, wherein said step (e) comprises adding said shift value to said target coordinate value and then normalizing said target coordinate value according to said magnification to obtain said calibrated target coordinate value.

5. The method of claim 1, wherein said step (e) comprises normalizing said target coordinate value according to said magnification to obtain said calibrated target coordinate value.

6. The method of claim 1, wherein said second midpoint coordinate value is obtained as being an average of said first coordinate value and said second coordinate value.

7. The method of claim 1, wherein said first label and said second label are black segments respectively.

8. The method of claim 1, wherein said target label comprises a gray-scale patch.

9. The method of claim 1, wherein said image-scanning module comprises a lens.

10. The method of claim 1, wherein said image-scanning module comprises a photo-sensing device.

11. The method of claim 10, wherein said photo-sensing device comprises a charge coupled device.

12. The method of claim 10, wherein said photo-sensing device comprises a contact image sensor.
